(19) United States
(12) Patent Application Publication
(10) Pub. No.: US 2019/0143585 A1
(43) Pub. Date: May 16, 2019

(54) ADDITIVELY MANUFACTURED VERTICAL WALL FROM SLURRY

(71) Applicant: GENERAL ELECTRIC COMPANY, Schenectady, NY (US)

(72) Inventors: David BARNHART, West Chester, OH (US); Douglas Gerard Konitzer, West Chester, OH (US)

(21) Appl. No.: 15/811,409

(22) Filed: Nov. 13, 2017

(51) Int. Cl. B29C 64/165; B29C 64/40; B22F 3/00

(52) U.S. Cl. CPC B29C 64/165; B29C 64/209; B22F 3/008; B29C 64/40

(57) ABSTRACT

A method of fabricating an object is provided. The method includes depositing a first material between second material such that the second material is at opposite sides of the first material, the first material forming a metal, ceramic, or metal-ceramic. The second material is selectively removable from the first material to reveal sidewalls of the first material so that the first material has a more uniform vertical profile than would be the case if the first material was deposited without the second material.

### INTRODUCTION

The present disclosure generally relates to a method adapted to perform additive manufacturing (“AM”) processes. More specifically, the present disclosure relates to a method of additively manufacturing a vertical wall from slurry, and utilizing a direct ink writing process to perform the same.

### BACKGROUND

Many systems, such as next generation turbine engines, require components and parts having intricate and complex geometries and/or bulk parts. Conventional techniques for manufacturing engine parts and components involve laborious processes. Direct Metal Laser Melting (DMLM), Direct Metal Laser Sintering (DMLS), and Selective Laser Sintering (SLS) are methods of making these metal parts. These methods generally use a focused laser to fuse, layer-by-layer, a three dimensional object from a bed of powdered material. These methods are capable of manufacturing metal parts, but may result in products having cracks, a rough surface finish that requires post-production machining, and non-equiaxed microstructures.

Robocasting or direct ink writing is another additive manufacturing technique in which a filament of a paste (known as an ‘ink’, as per the analogy with conventional printing) is extruded from a small nozzle while the nozzle is moved across a platform. The object is thus built by ‘writing’ the required shape layer by layer. In robocasting or direct ink writing, a 3-D CAD model is divided up into layers in a similar manner to other additive manufacturing techniques. A fluid (typically a ceramic slurry), referred to as an ‘ink’, is then extruded through a small nozzle as the nozzle's position is controlled, drawing out the shape of each layer of the CAD model. The ink exits the nozzle in a liquid-like state but retains its shape immediately, exploiting the rheological property of shear thinning. It is distinct from fused deposition modelling as it does not rely on the solidification or drying to retain its shape after extrusion.

Filament direct ink writing is an extrusion-based additive manufacturing process that deposits aqueous colloidal suspensions of ceramic powders in a continuous layer-by-layer fashion to produce complex-shaped dense ceramic parts.

Referring to FIG. 1, a cross-sectional diagram illustrates a comparison of green body specimen filament layer heights formed via direct ink writing with varied polymer molecular weight and (boron carbide) B₄C solids loading. A study was conducted to produce near-net shaped B₄C green-bodies using direct ink writing of highly loaded aqueous suspensions. To fabricate suspensions with maximum solids loading and ideal yield stresses and viscoelastic properties for direct writing, polyethlenimine (PEI), with average molecular weights of 25 k g/mol and 750 k g/mol, was chosen due to its large electrostatic potential with B₄C. As shown in FIG. 1, suspensions made with 50 and 52 vol. % B₄C with 25 k g/mol PEI and the 48 vol. % B₄C with 750 k g/mol PEI had yield stresses of less than 37 Pa, the lowest viscosity values over the applied shear rates, and G′eq (gel strength) values less than 300 Pa. The suspensions had low shape retention and did not possess sufficient strength to support additional deposited layers, resulting in filament layers that compressed under the weight of additional layers. All other suspensions had yield stresses ≥43 Pa and equilibrium storage modulus ≥700 Pa, which permitted layers with higher shape retention and sufficient strength to support the stacking of additional layers. The 56 vol. % B₄C suspension with 25 k g/mol PEI had the highest yield stress and equilibrium storage modulus.

In general, suspensions made with PEI 750 k g/mol molecular weight possessed higher shape retention than suspensions made with PEI 25 k g/mol molecular weight for the same solids loading. Still, there remains a need to produce a smooth surface of these suspensions when using direct write processes.

### SUMMARY

The following presents a simplified summary of one or more aspects of the present disclosure in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

The foregoing and/or other aspects of the present invention may be achieved by a method of fabricating an object. The method may include depositing a first material between second material such that the second material is at opposite sides of the first material, the first material forming a metal, ceramic, or metal-ceramic. The second material may be selectively removable from the first material to reveal sidewalls of the first material so that the first material has a more uniform vertical profile than would be the case if the first material was deposited without the second material.

The foregoing and/or aspects of the present invention may also be achieved by a method of fabricating an object. The method may include (a) depositing a functional material onto a substrate from a first nozzle to form a first layer of the functional material; (b) depositing a support material onto the substrate from a second and third nozzle, the support material deposited at opposite sides of the functional material on the first layer to shape the functional material; (c) repeating steps (a) and (b) at layers subsequent the first layer; and (d) removing the support material to define a uniform vertical profile of the functional material.

Other features and aspects may be apparent from the following detailed description, drawing and claims.

### BRIEF DESCRIPTION OF THE DRAWINGS

FIG. 1 is a cross-sectional diagram illustrating a comparison of green body specimen filament layer heights formed via direct ink writing with varied polymer molecular weight and B₄C solids loading.

FIG. 2 is a diagram of a three-headed printer nozzle for direct ink writing, according to an aspect of the present invention.

FIG. 3 is a diagram illustrating a functional material deposited on a substrate with support material deposited on opposite sides thereof, according to an aspect of the present invention.

FIG. 4 is a diagram illustrating the functional material on the substrate without the support material.

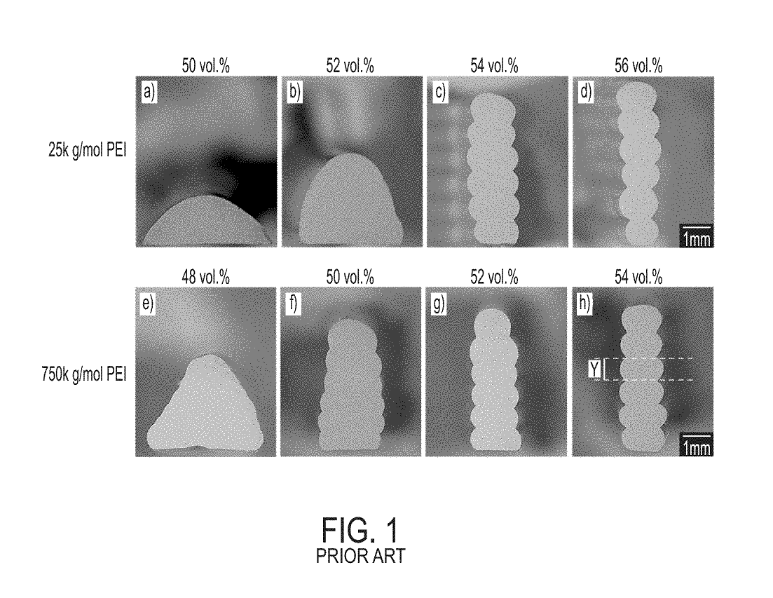

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The present disclosure relates to a method of additively manufacturing a vertical wall from slurry. The method may utilize a direct ink writing process to deposit first material between second material such that the second material may formed at opposite sides of the first material. The first material upon curing forms a metal, ceramic, or metal-ceramic. The second material may be selectively removable from the first material. The first and second materials may be applied in a manner that causes the first material to have a more uniform vertical profile than would be the case if the first material was deposited without the second material.

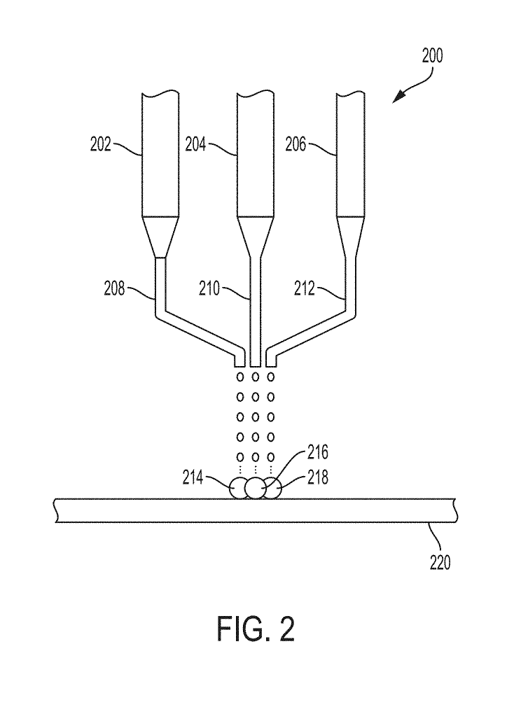

Referring to FIG. 2, a three-headed printer nozzle 200 includes dispensers 202, 204, and 206, each respectively having nozzles 208, 210, and 212 at an end thereof to deposit, for example, a bead forming material onto a substrate 220. The nozzle 210 may be configured to deposit a functional bead material 216 that forms, for example, a metal, ceramic, or metal-ceramic upon curing. The functional bead material 216 may be a slurry or material used with slurry. The nozzles 208 and 212 may be configured to deposit support material 214 and 216 such as, for example, a support wax material or plastic. The support material 214 and 216 may have a viscosity and density similar to the slurry material of the functional bead material 216.

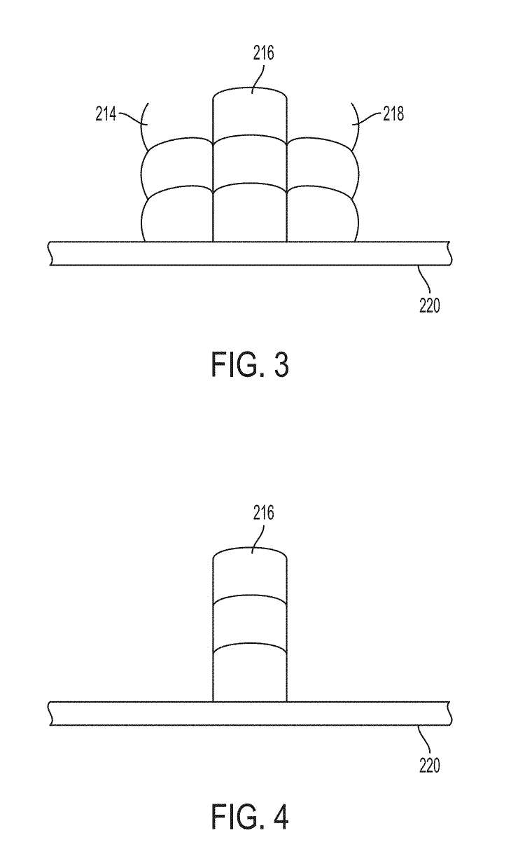

Referring to FIG. 3, the nozzle 210 deposits the functional material 216 layer by layer onto the substrate 220. The nozzles 208 and 212 may be configured to deposit the support material 214 and 218 concurrently with each deposited layer of the functional material 216 to maintain a uniform vertical profile of the functional material 216. Typically, as layers and layers of the functional material 216 are stacked, the functional material 216 may have a tendency to slump. For instance, the vertical profile of the functional material 216 may appear deformed at various layers. According to an aspect, the nozzles 208 and 212 may be configured to deposit the support material 214 and 218 at each layer of the deposited functional material 216 such that support material 214 and 218 abuts the functional material 216 at opposite sides. In an exemplary embodiment, the support material 214 and 218 may be abutted at opposite sides of the functional material 216 such that there is no space between the materials 214, 216, and 218 throughout the vertical build of the functional material 216 at each layer. In this way, for example, the support material 214 and 218 may be configured to shape the functional material 216 while supporting the functional material 216.

Referring to FIG. 4, various selective methods of removal may be used to remove the support material 214 and 218 from the functional material 216. For example, when heat is applied to the support material 214 and 218, the support material 214 and 218 may be melted away or disintegrated. As such, a vertical profile of the functional material 216 may be maintained. In another exemplary embodiment, the support material 214 and 218 may include a material that dissolves relative to a material used in the functional material 216 to achieve the vertical profile. For example, the support material 214 and 218 may include a water soluble wax in which case water may be used to remove the support material 214 and 218. The present invention may utilize other selective methods of removal dependent upon the characteristic of the support material 214 and 218 such as, for example, but not limited to, burning and evaporation.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

What is claimed is:

1. A method of fabricating an object, comprising:
depositing a first material between second material such that the second material is at opposite sides of the first material, the first material forming a metal, ceramic, or metal-ceramic, wherein the second material is selectively removable from the first material to reveal sidewalls of the first material so that the first material has a more uniform vertical profile than would be the case if the first material was deposited without the second material.

2. The method of claim 1, wherein the first material is a slurry.

3. The method of claim 1, wherein the first material is a material slurry.

4. The method of claim 1, wherein the second material is a wax.

5. The method of claim 1, wherein the second material is a plastic.

6. The method of claim 1, wherein the first and second material is deposited in the form of a bead.

7. A method of fabricating an object, comprising:
(a) depositing a functional material onto a substrate from a first nozzle to form a first layer of the functional material;
(b) depositing a support material onto the substrate from a second and third nozzle, the support material deposited at opposite sides of the functional material on the first layer to shape the functional material;
(c) repeating steps (a) and (b) at layers subsequent the first layer; and
(d) removing the support material to define a uniform vertical profile of the functional material.

8. The method of claim 7, wherein the functional material is a slurry or material slurry.

9. The method of claim 7, wherein the support material is a wax or plastic.
